(19) United States
(12) Patent Application Publication
(10) Pub. No.: US 2005/0080748 A1
(43) Pub. Date: Apr. 14, 2005

(54) Intermediated electronic payment system and method

(75) Inventors: Justin Belobaba, Toronto (CA); Adam Hutton, Toronto (CA); David Shaw, Toronto (CA); Josh Wozenilek, Toronto (CA)

Correspondence Address: NORRIS, MCLAUGHLIN & MARCUS, P.A., 875 THIRD AVE, 18TH FLOOR, NEW YORK, NY, 10022, US

(73) Assignee: toMarket Inc., Toronto (CA)

(21) Appl. No.: 10/683,690

(22) Filed: Oct. 10, 2003

(51) Int. Cl. G06F 17/60

(52) U.S. Cl. 705/65

(57) ABSTRACT

An intermediated electronic payment system and method. Electronic payments are made to an agent and a brokerage for a transaction involving a customer via a card, with the intermediation of a payment coordinator. A payment terminal is operated by the agent which transmits payment information and agent information via a telecommunication session to a receiving processor. The receiving processor captures the said information, obtains electronic authorization for the card payment, and sends a confirmation . The information are then sent to a payment processor operated by the payment coordinator. An amount of funds is transferred to a payment coordinator electronic fund transfer account through a brokerage trust account and a payment coordinator clearing account. Electronic fund transfers from the electronic fund transfer account are made to accounts of the agent and the brokerage for effecting an allocation determined by a split settlement processor in accordance with allocation rules.

### TECHNICAL FIELD OF THE INVENTION

This invention relates to system and method for intermediated electronic payment, in particular for a payment using a payment terminal.

### BACKGROUND OF THE INVENTION

Debit and credit are fast growing forms of payment, presently accounting for over 30% of transactions in the United States and nearly 50% in Canada. In Canada, debit has become major form of payment for transactions in the $15 to $100 range.

As an example, the North American taxi industry generates revenues of approximately $10 billion through 1 billion total transactions. Yet only one thousand of North America's one hundred thousand taxis accept both debit and credit card payment. The main reason for this is that taxi brokerages lack both the expertise and financial wherewithal to purchase and provide wireless payment terminals in their taxis.

In certain industries where payment for goods or services received by a customer occurs at the point of transaction using a payment terminal, an agent representing the provider of the goods or service (in the taxi industry, the latter known sometimes as a brokerage) typically receives remuneration for carrying out the transaction on a commission or excess basis (i.e. the agent receives any excess after a specified limit).

Currently in the taxi industry, when a wireless payment is made with a credit or debit card, funds are processed and then transferred to the taxi brokerage's bank account (rather than the driver's bank account). Taxi drivers eventually receive payment for these fares subsequently from the bank account of the taxi brokerage. In retail sales, the proceeds from a sale using a payment terminal will transfer first to the retailer's corporate bank account, with the salesperson receiving their commission-based pay thereafter from the retailer as part of the person's regular paycheque, or in addition to it. Thus, in all these cases, funds are transferred to the brokerage's bank account before being distributed to the agents operating the payment terminals.

The disadvantage of the above system is as follows: Taxi drivers must save all paper receipts from wireless transactions, and go to the brokerage office to be reimbursed. This requires a great deal of administration on the part of the taxi brokerage and wastes time for the taxi driver.

There is a need to provide a method and system for an automated payment system where payment to the agent and brokerage occurs as a separate process.

### SUMMARY OF THE INVENTION

This invention has the object to provide a method and a system for an automated payment system where payments to the agent and brokerage for a transaction involving card-based payment for goods or services between the customer and the brokerage occur as a separate process, reducing administration and time on the part of the agent and brokerage.

It does this by providing for a method using a payment processor and intermediated by a payment coordinator, comprising the steps of: communicating payment information and agent information via a telecommunication session between the payment terminal to a receiving processor over a communication network, said payment information entered into the payment terminal by the agent; carrying out card payment by the receiving processor capturing the payment information and the agent information, obtaining electronic authorization from a card issuing authority, and transmitting an electronic confirmation of the card payment to the payment terminal; sending the payment information and the agent information to a payment processor operated by the payment coordinator; transferring an amount of funds for the transaction to a payment coordinator electronic fund transfer account through a brokerage trust account and a payment coordinator clearing account, under direction of the payment processor; and performing electronic fund transfers from the payment coordinator electronic fund transfer account to an agent account and a brokerage account by executing an EFT execution file, the execution file prepared to effect an allocation of funds determined by a split settlement processor in accordance with a pre-determined set of allocation rules after receiving disbursement information from the payment processor.

This invention also provides for a system for electronically making the payments to the agent and the brokerage for the transaction, the transaction comprising a card-based payment by the customer intermediated by a payment coordinator and the system comprising: a payment terminal operated by the agent for wirelessly sending the payment information and agent information; a receiving processor operated by the payment coordinator for receiving the payment information and agent information from the payment terminal, and transmitting selectively the payment information and agent information; a payment processor operated by the payment coordinator for receiving the transaction information from the receiving processor, and transferring an amount of funds for the transaction to a payment coordinator electronic fund transfer account through a brokerage trust account and a payment coordinator clearing account, and preparing disbursement information for further transmission; and a split processor operated by the payment coordinator for receiving the disbursement information from the payment processor, and preparing an EFT execution file for execution at a financial institution housing the payment coordinator electronic fund transfer account, the EFT execution file prepared to effect an allocation of funds to an agent account and a brokerage account determined in accordance with a pre-determined set of allocation rules.

In accordance with a further embodiment of this embodiment, a method is provided for electronically making the said payments, comprising the steps of: communicating payment information and driver information via a telecommunication session between the payment terminal to a receiving processor over a GPRS communication network, said payment information entered into the payment terminal by the driver, and the payment terminal comprises hardware and software elements for identifying the agent, and at least one of the group comprising a built-in Wireless Application Protocol browser, a graphical display, a built-in printer, and a wireless phone; carrying out card payment by the receiving processor capturing the payment information and the driver information, obtaining electronic authorization from a card issuing authority, and transmitting an electronic confirmation of the card payment to the payment terminal; sending the payment information and the driver information to a payment processor operated by the payment coordinator; transferring an amount of funds for the transaction to a payment coordinator electronic fund transfer account through a taxi brokerage trust account and a payment coordinator clearing account, under direction of the payment processor; and performing electronic fund transfers from the payment coordinator electronic fund transfer account to an driver account, a taxi brokerage account and a payment coordinator account by executing an EFT execution file, the execution file prepared to effect an allocation of funds determined by a split settlement processor in accordance with a pre-determined set of allocation rules after receiving disbursement information from the payment processor.

### BRIEF DESCRIPTION OF THE DRAWINGS

FIG. 1 is a flow chart of the information and fund flow process in accordance with an embodiment of the invention.

### DETAILED DESCRIPTION OF THE EMBODIMENTS OF THE INVENTION

This invention is directed to a system and method for debit or credit payment via a payment terminal.

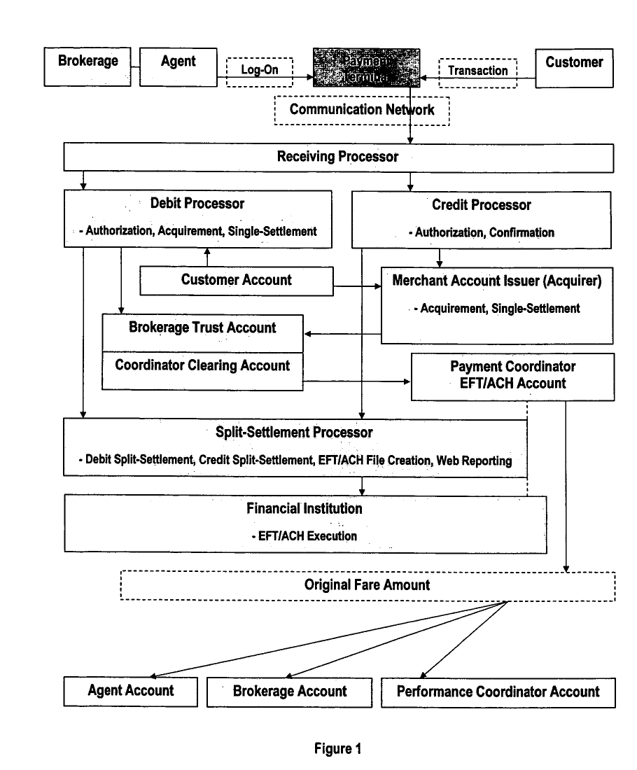

In a preferred embodiment of this invention, a payment terminal is supplied by a payment coordinator (the payment terminal may be owned by the payment coordinator; leased, rented, or provided free of charge by the payment coordinator or even a third party) to a Brokerage (indicated as “Brokerage”); the Brokerage then distributes to an agent (indicated as “Agent”), e.g. an employee, consultant or independent contractor of the Brokerage. The Agent would use the terminal (the same one everyday or potentially a different one each day) as an option for a customer (indicated as “Customer”) to pay for the transaction. The overall process is indicated in FIG. 1.

The payment terminal is adapted to process debit cards, credit cards, smart cards, corporate cards, and commercial cards. Each payment terminal stores a default identification code that represents the Brokerage. The Agent logs on to the terminal using some form of identification means. One such example is an identification card being a plastic card bearing identification information in electromagnetic media such as a magnetic strip. Alternatively, the payment terminal may contain a hardware and software unit (integrated or connected thereto) for capturing the identification of the Agent using biometric information of the latter. Such information may include thumbprint, retinal scan, and voice authentication. Every transaction processed by the terminal will contain that Agent's unique ID.

Typically, at the conclusion of a service performed by the Agent for which a charge applies, the Customer pays the charge. According to this invention, the charge is paid by the Customer using the payment terminal and a payment card, which, as mentioned earlier, is of a type selected from debit, credit or smart card (e.g. loyalty cards, stored value cards, corporate cards etc.). The Agent enters the proper transaction information including the card information (such as by “swiping” the card) and transaction amount. All of this transaction information, as well as the Agent's unique ID, are sent to a Receiving Processor over a communication network. The payment terminal could be wirelessly (on the GPRS, Mobitex, CPDP, or some Local Area Network) or not wirelessly (e.g. attached directly to a phone line) connected to the communication network.

The Receiving Processor includes a central processing unit, large capacity storage and database for storing the information of Agents, the Brokerage and transactions, communication elements to receive transaction information, and software elements for carrying out the functionality of the Receiving Processor as described in this document. The Receiving Processor permits Web Reporting by authorized parties (secure internet-based access to the database that stores records of transactions, enabling users to search through the data in an efficient and effective manner).

The Receiving Processor captures the financial transaction information sent from the terminal, obtains authorization from the card issuing authority (e.g. VISA™, bank, etc.), and sends an electronic confirmation of the transaction to the payment terminal. The payment terminal may be equipped (or connected to means therefore) to print a receipt for the transaction, which may then be passed to the Customer.

The Receiving Processor initiates the underlying payment process.

A portion or all of the revenue from the transaction is sent directly to the Agent's personal (or corporate) bank account (or to any account to which the Agent is directly tied—e.g. credit card account etc.). In a variation, the transaction amount is split-settled to numerous accounts including the Agent's account, the Brokerage's account, the payment coordinator's account, etc.

The flow chart in FIG. 1 illustrates a preferred embodiment whereby a payment coordinator (indicated as “Coordinator”) provides a payment terminal to a brokerage company who then gives the terminal to an Agent who uses the terminal for transaction-based sales with a Customer of which a portion or all of the revenue from the transaction is sent directly to the Agent's bank account.

This process begins when the Brokerage provides a wireless payment terminal to an Agent. In this case, the Brokerage and Agent are borrowing the terminal from the Payment Coordinator.

At the end (or as part) of a transaction, the Customer pays for the transaction using the payment terminal and transaction information flows to a Receiving Processor. In a preferred embodiment, the payment terminal communicates with the Receiving Processor via a General Packet radio Service (GPRS) GPRS network. GPRS networks have been implemented for mobile data communication. Preferably the payment terminal has an integrated dual band GSM/GPRS modem with options including a built-in Wireless Application Protocol (WAP) browser, a graphical display and a built-in printer. Additional possible features include means for navigation and browsing of terminal applications, and additional means that enables the unit to operate as a wireless phone over the GSM/GPRS network. Software means is provided at both the payment terminal and the Receiving Processor for secure communication. This may implement public key encryption and the Secured Socket Layer (SSL) protocol. The main advantages of using the GPRS network are that (1) it has a high bandwidth so that more information can be transferred at a faster speed, allowing transactions to be carried out quickly; and (2) it overlays a packet based air interface typically on an existing GSM or TDMA voice network.

The Receiving Processor includes a central processing unit, large capacity storage and database for storing the information of Agents, the Brokerage, and transactions, and software elements for carrying out the functionality of the Receiving Processor further described in this document.

Following the receipt of the transaction information by the Receiving Processor, information is sent to different processors depending on whether a debit or credit transaction has occurred. The information includes the information contained on the card (type of card, issuing institution, cardholder identification information) and the transaction amount.

Debit information is sent to a Debit Processor. The Debit Processor communicates with the relevant card issuing financial institution (such as a bank) for authorization to ensure that the Customer's account has the required funds for the transaction, acquires the funds from the Customer's account if the funds are sufficient, and then single-settles the funds into an account of the Payment Coordinator in trust for the Brokerage. At least the first step is done in real-time so that the Agent's transaction with the Customer can be concluded immediately. The subsequent steps can also be done in real-time, but this invention is not so limited.

Typically, the card-issuing financial institution operates its own hardware and software system for authorization and offers a communication interphase (such as through a phone line, a dedicated line, or the Internet) to third parties for authorization purposes. A positive authorization allows the transaction to proceed; a negative authorization prevents the transaction from completing.

The Debit Processor includes a central processing unit, large capacity storage and database for storing the information of Agents, the Brokerage, the card issuing financial institutions and account information of the Payment Coordinator (for the account held in trust for the Brokerage), and software and hardware elements for carrying out the functionality of the Debit Processor further described in this document.

Similarly, information for a credit transaction is sent to a Credit Processor. The Credit Processor authorizes the transaction in real-time with the relevant financial institution to ensure the Customer's credit card is valid and then confirms that the amount of the transaction is covered by the Customer's available credit.

As in the case of the debit processor, typically, the credit card issuing financial institution operates its own hardware and software system for authorization and offers a communication interphase (such as through a phone line, a dedicated line, or the Internet) to third parties for authorization purposes. A positive authorization allows the transaction to proceed; a negative authorization prevents the transaction from completing.

After these two steps, information concerning the payment is sent by the Credit Processor to an Acquirer. The Acquirer is the entity that provides credit card merchant accounts to each Brokerage, i.e. the merchant account issuer. Each Brokerage may have several Acquirers such as Paymentech™, Global Payment Systems™, American Express™, Diners Club™, Discover™, and any other type of Acquirer. Once the Acquirer receives this information, it acquires the funds from the relevant financial institution, which is a function of the card holder, and then single-settles the funds into a Payment Coordinator account held in trust for the Brokerage (just as in the case of a debit transaction).

The Credit Processor includes a central processing unit, large capacity storage and database for storing the information of Agents, the Brokerage, the card issuing financial institutions and account information of the Payment Coordinator (for the account held in trust for the Brokerage), and software and hardware elements for carrying out the functionality of the Credit Processor further in this document.

Now that the funds are in the Brokerage trust account (either debit or credit), they can be transferred into a Payment Coordinator clearing account on a typically daily basis. The financial institution that holds the Brokerage trust account and the Payment Coordinator clearing account normally provides this service. This financial institution may be a single institution or 2 separate institutions with electronic fund transfer being used. The funds will sit in the Payment Coordinator clearing account until such are electronically transferred to the Payment Coordinator EFT/ACH (electronic fund transfer/automated clearing house) account (possibly housed at a separate financial institution) as a result of the EFT/ACH execution described below.

In a variation of the above, the Payment Coordinator clearing account and the Payment Coordinator EFT/ACH (electronic fund transfer/automated clearing house) account are the same account, whether housed at the same as, or a separate financial institution from, the Brokerage trust account.

In a further variation, the Payment Coordinator, working with a number of Brokerages, acts as a “master merchant” under its merchant account issuers. This means that each of the above Brokerages does not have its own merchant account for the purpose of this embodiment, but the Payment Coordinator has a large merchant account and aggregates all of its Brokerages' transactions under this single merchant account. In this scenario, the debit and credit funds are single-settled directly into the Payment Coordinator clearing account rather than the Brokerage trust accounts (because the latter trust accounts do not exist in this scenario).

In another embodiment, this single merchant account is also the Payment Coordinator EFT/ACH account: only a single account is used for the entire process.

Optionally, the Payment Coordinator may be a “master merchant” with respect to only a subset of its Brokerages.

Not only does the Credit Processor send the transaction information to the merchant account issuer, but it also sends disbursement information to a Split-Settlement Processor. The Debit Processor typically also sends the transaction information directly to the Split-Settlement Processor. Once the Split-Settlement Processor receives this transaction information, it splits up the single transaction amount into various amounts based on specific criteria supplied by the Payment Coordinator and the Brokerage.

The Split-Settlement Processor creates an EFT/ACH file that contains information for the various amounts to be electronically disbursed and collected from bank accounts at various financial institutions. Once this file is created, it is sent (preferably electronically over secure channels) to a financial institution that provides the service of executing the EFT/ACHs (typically the institution that houses the Payment Coordinator EFT/ACH account)

Each EFT/ACH execution involves two main components: (1) Funds are disbursed from the Payment Coordinator EFT/ACH account into various bank accounts representing Agents, the Brokerage, and other related parties, including the Payment Coordinator's business account; and (2) Funds are collected from the Payment Coordinator clearing account so that there are sufficient funds to make the said disbursements, as referred to earlier.

Finally, the Agent receives his or her share of the original amount paid by the Customer into his or her account once the Payment Coordinator has completed its transaction settlement service. The Brokerage gets its share of the amount based on pre-determined rules, and the Payment Coordinator receives its remuneration, preferably at the same time the funds are settled to the Agent and Brokerage.

In a preferred embodiment, a taxi brokerage is the Brokerage indicated above; the taxi driver as the Agent leases the taxi plate and/or the vehicle and/or dispatching services and/or repair and maintenance services for a flat rate from the taxi brokerage; and a taxi rider is the Customer. Any fares the driver earns above this flat rate are his or hers to keep as income. Therefore, transactions processed through the payment terminal are sent directly to their bank account (in some cases, the taxi brokerage will receive a percentage of the fares or the Payment Coordinator will receive a percentage or flat fee of each transaction or a monthly fee for terminal usage, requiring split settling of the transaction). In other embodiments, the brokerage are players from the limousine industry, the airport shuttle industry, and virtually any industry in which a Customer pays the Agent at the point of the transaction; funds from the transaction may be transferred directly to the Agent's bank account; and the Agent pays the brokerage a fee to represent the brokerage and keeps the rest of the funds received from the Customer for himself or where commissions are earned by the Agent from the transaction based on sales.

The four processors mentioned above, namely Receiving, Credit, Debit, and Split-Settlement Processors, may be implemented as one or more hardware and software systems on one or more interconnected networks with telecommunication links to those of the other institutions such as the card issuing authority, the Acquirer, and financial institutions holding the Payment Coordinator clearing account and the Payment Coordinator EFT/ACH account. The telecommunication links interconnecting between the systems of the 4 processors and with the external systems may be via public networks (such as those implementing the Internet) or private networks (LAN, WAN, ATM, etc.). The only requirement on communication is the initial link from the payment terminals to the Receiving Processor be a wireless connection.

It will be appreciated that the above description relates to the preferred embodiments by way of example only. Many variations on the system and method for delivering the invention will be clear to those knowledgeable in the field, and such variations are within the scope of the invention as described and claimed, whether or not expressly described.

1. A method for electronically making a payment to an agent and a brokerage for a transaction involving payment for goods or services between a customer and the brokerage, the transaction comprising a card-based payment by the customer using a payment processor and intermediated by a payment coordinator, comprising the steps of:
communicating payment information and agent information via a telecommunication session between the payment terminal to a receiving processor over a communication network, said payment information entered into the payment terminal by the agent;
carrying out card payment by the receiving processor capturing the payment information and the agent information, obtaining electronic authorization from a card issuing authority, and transmitting an electronic confirmation of the card payment to the payment terminal;
sending the payment information and the agent information to a payment processor operated by the payment coordinator;
transferring an amount of funds for the transaction to a payment coordinator electronic fund transfer account through a brokerage trust account and a payment coordinator clearing account, under direction of the payment processor; and
performing electronic fund transfers from the payment coordinator electronic fund transfer account to an agent account and a brokerage account by executing an EFT execution file, the execution file prepared to effect an allocation of funds determined by a split settlement processor in accordance with a pre-determined set of allocation rules after receiving disbursement information from the payment processor.

2. The method of claim 1, wherein the card is a debit card and the payment processor comprises a debit processor.

3. The method of claim 2, wherein the step of transferring an amount of funds for the transaction to a payment coordinator electronic fund transfer account through a brokerage trust account and a payment coordinator clearing account comprises the prior step of:
transferring funds of the amount from an account of the customer with the debit card issuing institution into the brokerage trust account through an account of the payment processor.

4. The method of claim 1, wherein the card is a credit card and the payment processor comprises a credit processor.

5. The method of claim 4, wherein the step of transferring an amount of funds for the transaction to a payment coordinator electronic fund transfer account through a brokerage trust account and a payment coordinator clearing account comprises the prior steps of:
sending payment information to an acquirer; and
the acquirer remitting funds to the brokerage trust account for covering the payment.

6. The method of claim 1, wherein the brokerage trust account and the payment coordinator clearing account are the same account held at the same financial institution.

7. The method of claim 1, wherein the brokerage trust account, the payment coordinator clearing account, and the payment coordinator electronic fund transfer account are the same account held at the same financial institution.

8. The method of claim 1, wherein the step of performing electronic fund transfers from the payment coordinator electronic fund transfer account comprises a transfer to an payment coordinator account.

9. The method of claim 1, wherein the brokerage is one selected from the group comprising of a taxi brokerage, a limousine brokerage, and an airport shuttle brokerage.

10. The method of claim 1, wherein the payment terminal is a wireless payment terminal.

11. The method of claim 10, wherein the payment information and agent information are communicated over a GPRS network to the receiving processor.

12. The method of claim 1, wherein the payment terminal communicates with the receiving processor using a wired medium.

13. The method of claim 10, wherein the payment terminal comprises hardware and software elements for identifying the agent, and at least one of the group comprising a built-in Wireless Application Protocol browser, a graphical display, a built-in printer, and a wireless phone.

14. A system for electronically making a payment to an agent and a brokerage for a transaction involving payment for goods or services between a customer and the brokerage, the transaction comprising a card-based payment by the customer intermediated by a payment coordinator, comprising:
a payment terminal operated by the agent for wirelessly sending the payment information and agent information;
a receiving processor operated by the payment coordinator for receiving the payment information and agent information from the payment terminal, and transmitting selectively the payment information and agent information;
a payment processor operated by the payment coordinator for receiving the transaction information from the receiving processor, and transferring an amount of funds for the transaction to a payment coordinator electronic fund transfer account through a brokerage trust account and a payment coordinator clearing account, and preparing disbursement information for further transmission; and
a split processor operated by the payment coordinator for receiving the disbursement information from the payment processor, and preparing an EFT execution file for execution at a financial institution housing the payment coordinator electronic fund transfer account, the EFT execution file prepared to effect an allocation of funds to an agent account and a brokerage account determined in accordance with a pre-determined set of allocation rules.

15. The system of claim 1, wherein the card is a debit card and the payment processor comprises a debit processor.

16. The system of claim 15, wherein The debit processor effects a transfer of funds of the amount for the transaction from an account of the customer with the debit card issuing institution into the brokerage trust account through an account of the debit processor prior to transferring funds to the payment coordinator electronic fund transfer account through the payment coordinator clearing account.

17. The system of claim 14, wherein the card is a credit card and the payment processor comprises a credit processor.

18. The system of claim 17, wherein:
the credit processor sends payment information to an acquirer; and
the acquirer remits funds to the brokerage trust account for covering the payment prior to the transferring funds to the payment coordinator electronic fund transfer account through the payment coordinator clearing account, under instructions of the acquirer.

19. The system of claim 14, wherein the brokerage trust account and the payment coordinator clearing account are the same account held at the same financial institution.

20. The system of claim 14, wherein the brokerage trust account, the payment coordinator clearing account, and the payment coordinator electronic fund transfer account are the same account held at the same financial institution.

21. The system of claim 14, wherein the allocation of funds further includes a disbursement to an payment coordinator account to be effected by the electronic fund transfer.

22. The system of claim 14, wherein the brokerage is one selected from the group comprising of a taxi brokerage, a limousine brokerage, and an airport shuttle brokerage.

23. The system of claim 14, wherein the payment terminal is a wireless payment terminal.

24. The system of claim 23, wherein the payment information and agent information are communicated over a GPRS network to the receiving processor.

25. The system of claim 14, wherein the payment terminal communicates with the receiving processor using a wired medium.

26. The system of claim 24, wherein the payment terminal comprises hardware and software elements for identifying the agent, and at least one of the group comprising a built-in Wireless Application Protocol browser, a graphical display, a built-in printer, and a wireless phone.

27. A method for electronically making a payment to a driver and a taxi brokerage for a transaction involving payment for a taxi fare between a rider and the taxi brokerage, the transaction comprising a card-based payment by the rider using a wireless payment processor and intermediated by a payment coordinator, comprising the steps of:
communicating payment information and driver information via a telecommunication session between the payment terminal to a receiving processor over a GPRS communication network, said payment information entered into the payment terminal by the driver, and the payment terminal comprises hardware and software elements for identifying the agent, and at least one of the group comprising a built-in Wireless Application Protocol browser, a graphical display, a built-in printer, and a wireless phone;
carrying out card payment by the receiving processor capturing the payment information and the driver information, obtaining electronic authorization from a card issuing authority, and transmitting an electronic confirmation of the card payment to the payment terminal;
sending the payment information and the driver information to a payment processor operated by the payment coordinator;
transferring an amount of funds for the transaction to a payment coordinator electronic fund transfer account through a taxi brokerage trust account and a payment coordinator clearing account, under direction of the payment processor; and
performing electronic fund transfers from the payment coordinator electronic fund transfer account to an driver account, a taxi brokerage account and a payment coordinator account by executing an EFT execution file, the execution file prepared to effect an allocation of funds determined by a split settlement processor in accordance with a pre-determined set of allocation rules after receiving disbursement information from the payment processor.
